(19) United States
(12) Patent Application Publication
(10) Pub. No.: US 2008/0231218 A1
(43) Pub. Date: Sep. 25, 2008

(54) APPARATUS AND METHOD OF DRIVING MOTOR, AND DRIVE APPARATUS USING THE SAME

(75) Inventors: Kyoung-whan OH, Seoul (KR); Soo-young Choi, Suwon-si (KR); Nam-guk Kim, Anyang-si (KR); Su-Hwan Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/052,034

(22) Filed: Mar. 20, 2008

(30) Foreign Application Priority Data
Mar. 20, 2007 (KR) 2007-27222

(51) Int. Cl. H02P 6/08; H02P 6/06; H02P 7/29; H02P 6/18

(52) U.S. Cl. 318/400.11; 388/829; 388/811; 318/400.42; 318/400.34; 318/400.12

(57) ABSTRACT

An open-loop driving method of a spindle motor includes determining of whether open-loop driving conditions for the spindle motor are met, and adjusting widths of driving pulses applied to the spindle motor according to a predictive speed variation of the spindle motor when it is determined that the open-loop driving conditions for the spindle motor are met.

### CROSS-REFERENCE TO RELATED APPLICATIONS

This application claims priority under 35 U.S.C. 119(a) from Korean Patent Application No.: 2007-27222, filed on Mar. 20, 2007, in the Korean Intellectual Property Office, the disclosure of which is incorporated herein in its entirety by reference.

### BACKGROUND OF THE INVENTION

1. Field of the Invention

The present general inventive concept relates to an apparatus and method of driving a motor, and more particularly, to an open-loop driving method and apparatus to control a motor in an open loop driving mode, and a disk drive apparatus using the same.

2. Description of the Related Art

A conventional driving method of a spindle motor is disclosed in Korean Patent Application Publication 2005-024972 and Japanese Patent Application Publication Hei 8-115565.

A conventional disk drive using a spindle motor includes a hard disk drive, a CD-ROM drive, a digital versatile disk (DVD) drive, etc.

The hard disk drive rotates a disk at a desirable speed using a spindle motor and writes and reads data on and from the disk using a magnetic head. When power is supplied to the hard disk drive, it is an important evaluation factor of the hard disk drive to control the spindle motor to reach a target speed or RPM.

Generally, a method of driving of the spindle motor is divided into an open loop driving and a closed loop driving.

The closed loop driving is a method of detecting a back electromotive force generating when a motor is driven, and controlling the motor using the detected back electromotive force. The closed loop driving is performed using the back electromotive force since a disk drive does not use a separate sensor to detect the speed and acceleration during driving a spindle motor.

The open loop driving is a method performed before the closed loop driving when the back electromotive force is not detected or when the detected back electromotive force is not reliable to a desired level.

In the conventional disk drive, the open loop driving method repeatedly drives the spindle motor by repeatedly supplying a current pulse having a constant amplitude and a constant driving time width until the back electromotive force is detected to the reliable level which is a target speed of, for example, 300 RPM. Accordingly, it is disadvantageous that a time period to perform the open loop driving method is extended. In addition, when the number of disks mounted in the hard disk drive in response to demands on a storage capacity of the hard disk drive, the inertia of the spindle motor is increased according to the increased number of the disks, so that the time period to perform the open loop driving method is extended according to the increased inertia of the spindle motor.

### SUMMARY OF THE INVENTION

The present general inventive concept provides a driving method of changing a unit driving time interval to drive a spindle motor in an open loop driving mode, so that a driving period of the open loop driving mode is decreased, and a disk drive apparatus using the same.

The present general inventive concept also provides a computer-readable medium containing computer-readable codes as a program to perform a method of changing a unit driving time interval (period) to drive a spindle motor in an open loop driving mode.

Additional aspects and utilities of the present general inventive concept will be set forth in part in the description which follows and, in part, will be obvious from the description, or learned by practice of the general inventive concept.

The foregoing and/or other aspects and utilities of the present general inventive concept may be achieved by providing A method of a disk drive apparatus to drive a motor in an open loop mode, the method comprising: changing widths of one or more driving pulses to be applied to a motor according to a predictive speed variation of the motor, in an open-loop driving mode.

The method may further include applying reference driving pulses having a constant width to the motor, detecting a speed of the motor according to the applied reference driving pulses, and setting up the predictive speed according to the detected speed with respect to a time axis.

The method may further include storing the predictive speed in a memory as a look-up table, wherein the changing of the widths of the driving pulses may include changing the widths of the driving pulses according to the look-up table.

The applying of the reference driving pulses may include detecting a reference speed and a reference time taken to reach the reference speed, and the changing of the widths of the driving pulses may include generating the driving pulses having the changeable widths to be supplied to the motor such that a time taken to the reference speed of the motor according to the driving pulses are shorter than the reference time.

The predictive speed may include a driving time period during which the driving pulses are generated.

The predictive speed may include unit driving times to correspond to the variable widths of the driving pulses.

The open-loop driving mode may include a mode to control the motor from a stationary state to a rotation state.

The driving pulses may include a first driving pulses, a second driving pulse, and a third driving pulse, the widths may include a first width, a second width, and a third width, and the changing of the widths of the driving pulses may include sequentially generating the first driving pulse with the first width, the second driving pulse with the second pulse, and the third driving pulse with the third width.

The first width may be wider than the third width.

The widths of the driving pulses may decrease with respect to a time axis.

The method may further include detecting a characteristic of the motor, and determining the open loop driving condition according to the detected characteristic of the motor.

The characteristic of the motor may include at least one of a load, a speed, a position of the motor.

The predictive speed variation of the motor may represent a variation of the predictive speed determined according to an environment factor of the motor.

The method may further include determining whether the open loop driving mode of the motor is met, wherein the changing of the widths of the driving pulses may include changing the width according to the determination.

The open-loop driving condition for the motor may be met when a back electromotive force is detected from the motor; and the detected back electromotive force may be smaller than a predetermined reference critical value.

The open-loop driving mode of the motor may be changed to a closed-loop driving mode when a back electromotive force of the motor is greater than a predetermined reference critical value after repeating driving the motor in a unit driving interval having the driving pulses, and detecting a position of a rotor of the motor.

The changing of the widths of the driving pulses may include changing the widths of the driving pulses in reverses proportional to a speed of the motor predicted according to a period of time taken to initial-drive the motor.

The changing of the widths of the driving pulses may include changing the widths of the driving pulses in proportional to a rotation load of the spindle motor predicted according to a period of time taken to initial-drive the spindle motor.

The changing of the widths of the driving pulses may include changing the widths of the driving pulses according to information set in a look-up table on a unit driving time period optimized by to a rotation load of the spindle motor with respect to a period of time taken to drive the spindle motor.

The widths of the driving pulses may be determined according to the unit driving time period, and the unit driving time period may be determined in proportional to the rotation load of the spindle motor.

The widths of the driving pulses may be determined according to a function representing a trajectory of an optimized unit driving time period calculated based on a predictive speed trajectory of the motor.

The open-loop driving mode may include repeating a driving mode to drive the motor according to the driving pulses and a sensing mode to sense a rotation position of a rotor of the motor.

The foregoing and/or other aspects and utilities of the present general inventive concept may also be achieved by providing a disk drive apparatus including a disk, a motor to rotate the disk, and a controller to change widths of one or more driving pulses to be applied to the motor according to a predictive speed variation of the motor, in an open-loop driving mode.

The apparatus may further include a memory to store a look-up table including the predictive speed variation of the motor, wherein the predictive speed variation may represent a variation of the widths of the pulses along a time axis.

The predictive speed variation may represent a unit driving time period in which the controller generates the driving pulses.

The predictive speed variation may represent a time taken to reach a speed of the motor according to the driving pulse, and the time is shorter than a reference time taken to reach a speed of the motor according to reference driving pulses having a constant width.

The driving pulses may include a first driving pulses, a second driving pulse, and a third driving pulse, the widths may include a first width, a second width, and a third width, and the controller may sequentially generate the first driving pulse with the first width, the second driving pulse with the second pulse, and the third driving pulse with the third width.

The first width may be wider than the third width.

The widths of the driving pulses may decrease with respect to a time axis.

The predictive speed variation of the motor may represent a variation of the predictive speed determined according to an environment factor of the motor.

The controller may determine whether the open loop driving mode of the motor is met, and changes the width according to the determination.

The controller may determine the open-loop driving mode when a back electromotive force is detected from the motor; and the detected back electromotive force may be smaller than a predetermined reference critical value.

The open-loop driving mode of the motor may be changed to a closed-loop driving mode when a back electromotive force of the motor is greater than a predetermined reference critical value after repeating driving the motor in a unit driving interval having the driving pulses, and detecting a position of a rotor of the motor.

The controller may change the widths of the driving pulses in reverses proportional to a speed of the motor predicted according to a period of time taken to initial-drive the motor.

The controller may change the widths of the driving pulses in proportional to a rotation load of the motor predicted according to a period of time taken to initial-drive the motor.

The controller may change the widths of the driving pulses according to information set in a look-up table on a unit driving time period optimized by to a rotation load of the motor with respect to a period of time taken to drive the motor.

The widths of the driving pulses may be determined according to the unit driving time period, and the unit driving time period may be determined in proportional to the rotation load of the motor.

The widths of the driving pulses may be determined according to a function representing a trajectory of an optimized unit driving time period calculated based on a predictive speed trajectory of the motor.

The open-loop driving mode may include repeating a driving mode to drive the motor according to the driving pulses and a sensing mode to sense a rotation position of a rotor of the motor.

The controller may generate a driving control signal having a unit driving time period variable according to an initial driving time period of the motor when a condition for the open loop driving mode is met, and the driving pulses may be generated according to the driving control signal, and are supplied to the motor.

The controller may perform the open-loop driving when a back electromotive force is detected from the spindle motor, and the detected back electromotive force may be smaller than a predetermined reference critical value.

The controller may change the open-loop driving to a closed-loop driving condition when the detected back electromotive force is greater than a predetermined reference critical value after repeating driving the motor with a unit driving pulse and detecting a position of a rotor of the motor.

The controller may generate the driving control signal having the unit driving time period variable in reverses proportional to a speed of the motor predicted according to a period of time taken to initial-drive the motor.

The controller may generate the driving control signal having the unit driving time period variable in proportional to a rotation load of the motor predicted according to a period of time taken to initial-drive the motor.

The controller may generate the driving control signal according to information set in a look-up table on the unit driving time period optimized by to a rotation load of the motor with respect to a period of time taken to drive the motor.

The width of the driving pulse may be determined according to the unit driving time period, and the unit driving time period may be determined in proportional to the rotation load of the motor.

The controller may change the unit driving time period of the spindle motor according to a time taken to drive the motor using a function representing a trajectory of an optimized unit driving time period calculated based on a predictive speed trajectory of the motor.

The controller may repeat a driving mode to drive the motor according to the driving pulse and a sensing mode to sense a rotation position of a rotor of the motor, in the open-loop driving conditions for the motor.

The foregoing and/or other aspects and utilities of the present general inventive concept may also be achieved by providing a computer-readable medium to contain computer-readable codes as a program to perform a method of driving a motor in an open loop mode of a disk drive apparatus, the method including changing widths of one or more driving pulses to be applied to a motor according to a predictive speed variation of the motor, in an open-loop driving mode.

### BRIEF DESCRIPTION OF THE DRAWINGS

These and/or other aspects and utilities of the present general inventive concept will become apparent and more readily appreciated from the following description of embodiments, taken in conjunction with the accompanying drawings of which:

FIG. 1 is a plan view illustrating a disk driving apparatus according to an embodiment of the present general inventive concept;

FIG. 2 is a circuit block diagram illustrating a disk drive apparatus using an open loop driving method according to an embodiment of the present general inventive concept;

FIG. 3 is a view illustrating a brushless DC motor of a disk drive apparatus according to an embodiment of the present general inventive concept;

FIG. 4 is a flowchart illustrating an open loop driving method of a disk drive apparatus according to an embodiment of the present general inventive concept;

FIG. 5 is a view illustrating driving pulses having constant driving periods applied to a motor driving unit in a disk driving apparatus according to an embodiment of the present general inventive concept;

FIG. 6 is a view illustrating driving pulses having variable driving periods to be applied to a motor driving unit of a disk drive apparatus according to an embodiment of the present general inventive concept;

FIG. 7 is a view illustrating a reference motor speed and a constant driving interval (width) of driving pulses with respect to a time axis according to the driving pulses of FIG. 5;

FIG. 8 is a view illustrating a predictive motor speed and a variable driving interval (width) of driving pulses with respect to a time axis according to the driving pulses of FIG. 6; and

FIG. 9 is a view illustrating a reference spindle motor speed and a predictive motor speed according to a constant driving interval of driving pulses and a variable driving interval of driving pulses, respectively, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A disk drive apparatus, such as a data storage medium, a recording and reproducing apparatus, a hard disk drive apparatus, an optical disk drive apparatus, etc., using an open-loop driving method according to the embodiment of the present general inventive concept may include a combination of a motor unit and a circuit to drive the motor unit.

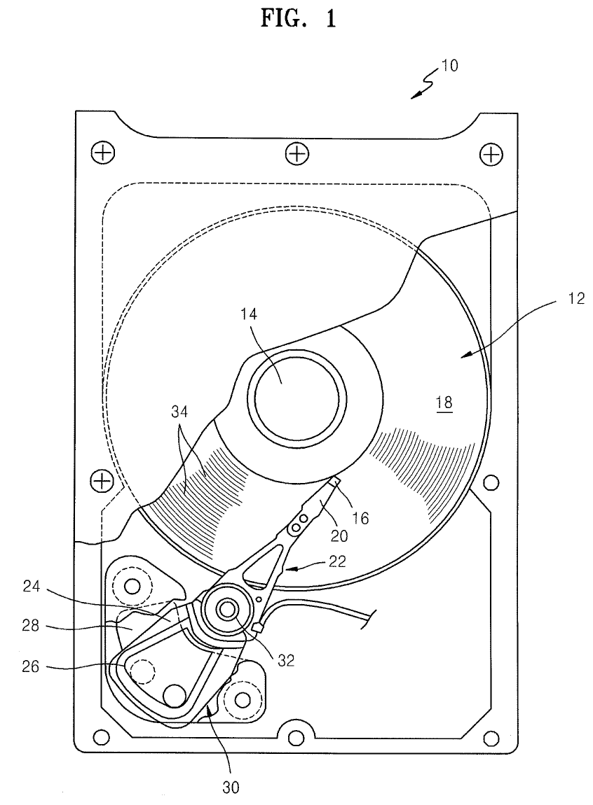

FIG. 1 is a plan view illustrating a disk driving apparatus, such as a head disk assembly 10, according to an embodiment of the present general inventive concept. The disk drive apparatus may be a data storage medium, a recording and reproducing apparatus, a hard disk drive apparatus, etc., using an open-loop driving method according to the embodiment of the present general inventive concept. The disk drive apparatus may be an apparatus having a combination of a motor unit and a circuit to drive the motor unit according to the open-loop driving method. Hereinafter, the head disk assembly 10 will be described as an example of the apparatus using the open-lop driving apparatus according to the present embodiment.

The head disk assembly 10 includes one or more disks 12 to rotate by a motor, such as a spindle motor 14. The disk drive apparatus includes a converter 16 disposed adjacent to a surface of the disk 12.

The converter 16 detects a magnetic field of the respective disks 12 and magnetizes the disks 12 to read and write information. The converter 16 may be a plurality of converters disposed to face the corresponding disks 12. The converter 16 may include a recording head to magnetize the disk 12 to write the information and a reading head to detect the magnetic field to read the information. The reading head includes a magnetor-resistive component. The converter 16 is referred to as a magnetic head.

The converter 16 is formed on a slider 20. The slider 20 has a structure to generate an air bearing between the converter 16 and a surface of the disk 12. The slider 20 is combined with a head gimbal assembly 22. The head gimbal assembly 22 is connected to an actuator arm 24 having a voice coil 26. The voice coil 26 is disposed adjacent to a magnetic assembly 28 on which a voice coil motor 30 is mounted. A current is supplied to the voice coil 26 to generate a torque to rotate the actuator arm 24 with respect to a bearing assembly 32. The actuator arm 24 rotates with respect to the disk 12 to move the converter 16 across the surface of the disk 12.

Information is stored in the circular track 34 of the disk 12. Each track 34 includes a plurality of sectors each having data field and an identification field. The identification field includes a gray code to represent the sector and the track (cylinder). The converter 16 moves across the surface of the disk 12 to read and write information from and on the different tracks 34.

A brushless direct current (DC) motor can be used as the spindle motor 14 according to the present embodiment.

In a method of driving the brushless DC motor, a position (location) of a rotor can be determined by a method using a back electromotive force or an inductance variation without using a sensor to detect the position of the rotor, to determine a current direction flowing to phases (phase units) of the brushless DC motor. In this case, the rotor can receive a rotation force according to an driving torque generated by the current flowing to the phases according to the determined current direction in an driving mode. Here, in the initial driving mode, it is determined that which one of the phases is first supplied with the current, according to the position (location) of the rotor. If the current is supplied to a U phase first and then to a V phase, a driving process of supplying the current to the U phase and then a W phase, and to the V phase and then W phase repeats.

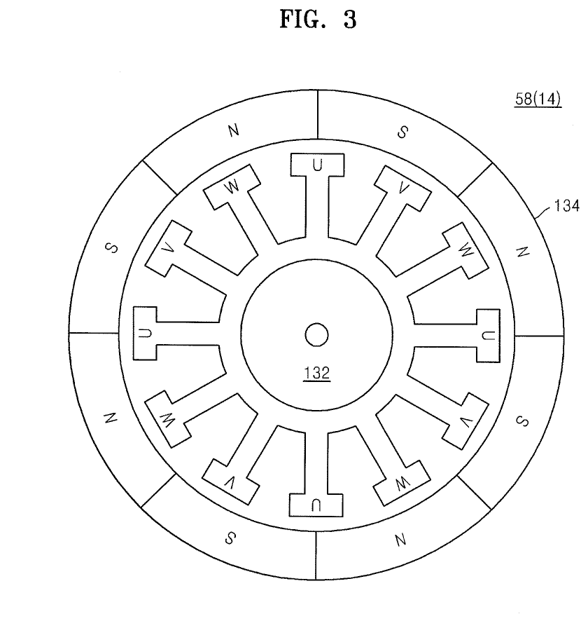

FIG. 3 is a view illustrating a brushless DC motor of a disk drive apparatus according to an embodiment of the present general inventive concept. According to the present embodiment, the brushless DC motor may include eight (8) polarities and twelve (12) slots. A stator 134 may have a circular permanent magnet formed with eight (8) polarities of N and S polarities. A rotor 132 is a unit to form a rotation magnetic field with the stator 134 and may have an armature core formed with twelve (12) protrusions and slots, and a plurality of coils (not illustrated) winding around the respective projections to generate a driving torque to rotate the rotor 132 with respect to the stator 134. Here, the coils are divided into four (4) groups each being supplied with a voltage having three different phases, for examples, U, V, and W phases.

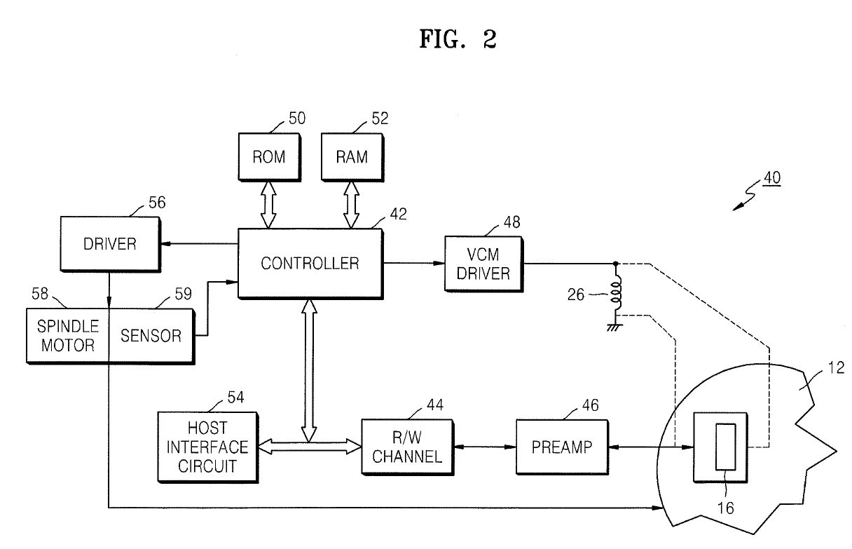

FIG. 2 is a block diagram illustrating a circuit system 40 of a disk drive apparatus using an open loop driving method according to an embodiment of the present general inventive concept. Referring to FIGS. 1 and 2, the circuit system 40 includes a read/write channel circuit 44 and a controller 42 connected to the converter 16 through a pre-amplifier (PERAMP) 46.

The controller 42 may be a digital signal processor (DSP), a microprocessor, or microprocessor. The controller 42 controls a read/write channel circuit 44 to read from or write on the disk information according to a command input from a host (not illustrated) through a host interface circuit 54.

The controller 42 is connected to a voice coil motor (VCM) driver 48 to supply a driving current to the voice coil 26. The controller 42 supplies a controller signal to the VCM driver 48 to control a movement of the converter 16.

In addition, the controller 42 generates a driving control signal to a spindle motor driver 56 to control a rotation of the spindle motor 14.

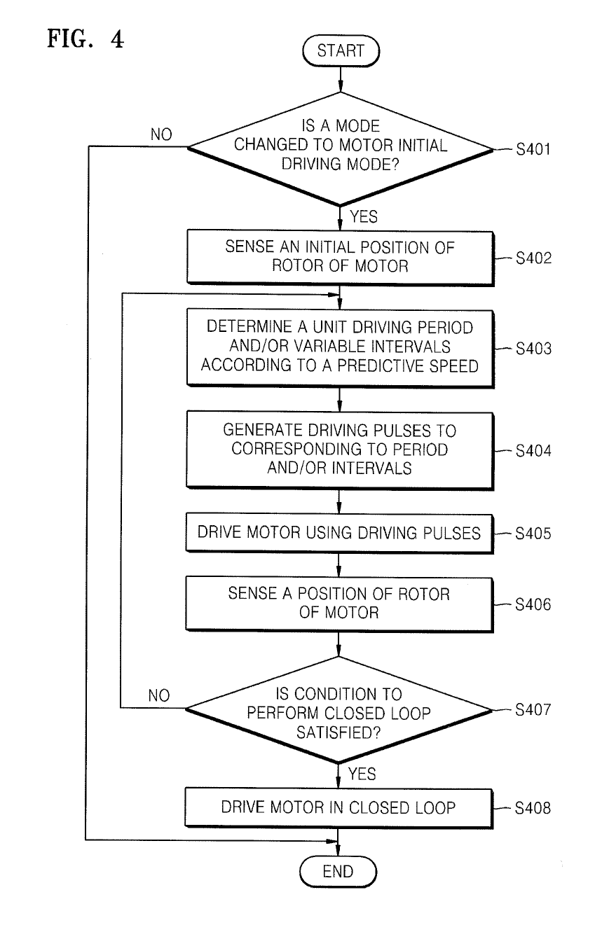

In a case of the open loop driving method of the spindle motor 14, the controller 42 generates a driving signal having one or more pulses with a variable interval (variable width or variable duty cycle) variable according to a time lapse of driving the spindle motor 14, and inputs the generated driving signal to the spindle motor driver 56 to drive the spindle motor 14. The driving signal may include one or more pulses each having the variable interval (variable width or variable duty cycle). A process of the open loop driving method to be performed in the controller 42 will be explained with reference to a flowchart of FIG. 4.

A ROM 50 stores a firmware and various control data to control a disk drive apparatus. The ROM can store a program to perform the open loop driving method of the disk driving apparatus as illustrated in FIG. 4, and a look-up table having information on a unit driving period of each open loop driving mode, and the variable interval of the driving pulses of the unit driving period to be used in the open loop driving method according to an embodiment of the present general inventive concept. The unit driving period may be determined according to the number of driving pulses and/or the widths (intervals) of the driving pulses. The width of each driving pulse may vary with respect to a unit width (unit interval). The widths of the driving pulses may vary from a wider (longer) interval to a narrow (shorter) interval with respect to the unit width (unit interval). It is possible that the width of each driving pulse can be referred to as a unit width (unit interval), and the unit width (unit interval) varies according to a time axis.

The unit driving time information may be a driving time period during which the open loop method is performed to generate the driving pulses having the variable interval (variable width or variable duty cycle) varying within the driving time period.

The open loop method may include a single unit driving time period during which the driving pulses having the variable interval (variable width or variable duty cycle) are generated. It is also possible that the open loop may have two or more unit driving time periods each variable and having the variable interval (variable width or variable duty cycle) of the pulses vary within each of the driving time periods. The unit driving time period may be determined according to characteristics of the driving pulses, such as, intervals or widths which vary with respect to a unit width or interval. It is possible that the number of driving pulses and/or the widths (intervals) of the driving pulses may be determined according to the unit driving time period which is shorter than a conventional driving time period.

The look-up table can be set up before the open loop method is performed, or can be set-up in a manufacturing process of the disk drive apparatus. When the disk drive apparatus performs the open loop method, the controller 42 controls the spindle motor 14 of FIG. 1 (or 58 of FIG. 2) by generating the pulses having the variable intervals within the driving time period according to the information of the look-up table according to an embodiment of the present general inventive concept.

A RAM 52 is loaded with disk drive information read from a maintenance cylinder (or a system cylinder) area of the disk 12 when a power is supplied to the disk drive apparatus.

The operation of the disk drive apparatus of FIGS. 1 and 2 is as follows.

In a data reading mode, the disk drive apparatus amplifies an electrical signal detected from the disk 12 by the converter 16 according to a predetermined gain of a pre-AMP 46, converts the amplified signal read from the disk 12 into a digital signal according to a sector pulse generated from the controller 42, and processes or decodes the converted digital signal. The decoded or processed data (or signal) is converted into stream data after error-correction using a Reed-Solomon code in the controller 42. The stream data is transmitted to a host apparatus though a host interface circuit 54.

In a data writing mode, the disk drive apparatus receives data from a host apparatus (not illustrated) through a host interface circuit 54, adds an error correction parity symbol to the data according to the Reed-Solomon code in the controller 42, encodes or processes the data to be optimized or adjusted by the read/write channel circuit 44, and writes the data as a record current amplified in the pre-AMP 46 and converted in the converter 16 on the disk 12 according to a generating time of the sector pulse.

The controller 42 controls the spindle motor driver 56 to initial-drive and rotate the spindle motor 58 using the open loop driving method according to an embodiment of the present general inventive concept will be described with reference to FIG. 4.

The controller 42 determines whether the disk drive apparatus is changed from a mode to an initial driving mode (or a spindle motor initial driving mode) to initial-drive the spindle motor 14 (or 58) in operation S401. The spindle motor initial driving mode to initial-drive the spindle motor may be a mode to control the disk 12 from a stationary state to a moving state. When the disk 12 rotates, data is read from or written to the disk 12. When a power is supplied to the disk drive apparatus, when a read or write command is input from a host apparatus, or when the disk drive apparatus is in a parking mode in which the converter 16 is disposed in a parking area near the disk 12, the controller 42 changes the mode to the spindle motor initial driving mode.

The spindle motor 58 initial driving mode may correspond to an initial mode and/or an open loop drive mode of the open loop method. In the initial mode, the spindle motor 58 may be supplied with an initial potential to start rotation, and a sensor 59 may detect a signal from the spindle motor 58. The signal may be a signal representing a speed of the spindle motor 58 (or rotor), a phase of the spindle motor 58 (or rotor), or a location of the rotor with respect to the stator, or a back electromotive power of a potential or current generated from the spindle motor 58. In the open loop method, the spindle motor 58 may be supplied with the driving pulses with variable intervals of the driving time period according to the detected signal, until the spindle motor 58 is changed from the open loop method to the closed loop. It is possible that the spindle motor 58 is driven by the open loop method in the initial driving mode without performing the initial mode. When a level of the back electromotive power is greater than a reference, the open loop method is changed to the closed loop method to further drive the spindle motor 58.

Since the spindle motor 14 uses a brushless DC motor without a speed and acceleration sensor, a speed and a phase can be sensed by a back electromotive power sensor using a back electromotive force generating from rotation of the motor. Here, in a low speed of the initial-driving mode, since a back electromotive signal corresponding to the back electromotive force has a very low level, it is difficult to sense the speed and phase of the spindle motor 14.

Here, when a level of the back electromotive signal generated from the spindle motor 14 is not greater than a desirable level, an open loop driving mode (open loop control) is performed, and when the level of the back electromotive signal generated from the spindle motor 14 is greater than the desirable level, a closed loop driving mode (closed loop control) is performed. In the closed loop control, the speed and phase can be sensed and determined using the back electromotive signal generated from the spindle motor 14, and the speed and phase can be controlled according to the determined speed and phase of the spindle motor.

Accordingly, when a mode of the hard disk apparatus is changed to the spindle motor initial driving mode, the open loop control is performed, and after the desired level of the back electromotive signal is sensed, the open loop driving mode is changed to the closed loop driving mode, so that the closed loop control is performed.

Referring back to FIG. 4, when the mode is changed to the spindle motor initial driving mode in operation S401, an initial position of the rotor of the spindle motor 14 is sensed in operation S402. A method of sensing the initial position of the spindle motor 14 may include applying a voltage vector with six types of voltage variances (or three phases of voltage variances) to the rotor 132 of the spindle motor 14, and sensing the initial position of the rotor 132 of the spindle motor 58 with respect to the stator 134 or a reference position of the spindle motor 14 according to a voltage change of output from the spindle motor 14, for example.

The controller 42 determines a unit driving period and/or variable intervals according to a predictive speed of the spindle motor 14 in operation S403.

When the unit driving period is determined according to variation of the predictive speed which is stored in the look-up table, the intervals (widths) of the respective driving pulses can be determined within the unit driving period. In this case, the unit driving period can be repeated during the open loop method until the level of the back electromotive signal is greater than a reference enough to perform the closed loop method. The unit driving periods can vary according to the speed or position of the spindle motor 58 or the back electromotive signal, and the driving pulses may be different to correspond to the respective unit driving periods.

It is also possible that the intervals (widths) of the respective driving pulses can be determined without determining the unit driving period. In this case, a unit interval may be determined to correspond to all the driving pluses, and the driving intervals (widths) of the respective driving pulses can vary with respect to the unit interval. That is, a ratio between the unit interval and the driving interval of each driving pulse is changed such that a current is supplied to the spindle motor 58 during the driving interval of the driving pulse with respect to the unit interval.

The predictive speed of the spindle motor 58 (or 14) can be set and stored as the look-up table during a designing or manufacturing process of the disk drive apparatus. In a proves of setting up the predictive speed, a fixed constant time is used to drive the spindle motor 58 in an initial driving mode, and a speed of the spindle motor 14 is detected with respect to a lapse of time from an initial-driving time of the initial driving mode when the spindle motor 58 is initially driven.

That is, as illustrated in FIG. 5, when one or more driving pulses having a constant interval (width) are applied to the spindle motor 58, the speed of the spindle motor 58 is detected, and the predictive speed of the spindle motor 14 is determined according to the lapse of time from a starting time of the initial-driving of the spindle motor. That is, the predictive speed of the spindle motor 14 is determined according to the detected speed with respect to a reference speed. In FIG. 5, driving pulses d₁, d₂, d₃, . . . dₖ, dₖ₊₁, dₙ₋₁, and dₙ are generated within a unit driving time period, and the intervals (widths) of driving pulses d₁, d₂, d₃, . . . , dₖ, dₖ₊₁, dₙ₋₁, and dₙ are constant and uniform with respect to a unit interval, the a fixed constant time (interval) is used to drive the spindle motor 58.

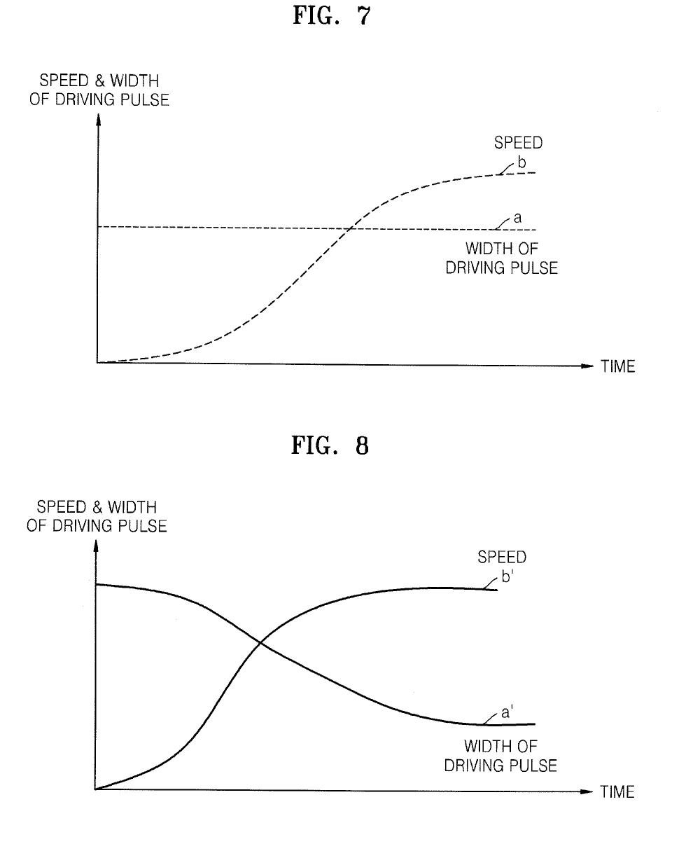

Referring to FIG. 7, when a fixed or constant width (a) of the driving pulses is used to drive the spindle motor 58 according to a time axis or a lapse of time, a reference speed “b” can be seen according to the time axis or the lapse of time. The width (a) of the driving pulses is constant along the time axis.

An amount of a rotation load of the spindle motor 14 can be detected from the detected speed as the reference speed “b” according to the lapse of time (or a time taken) from a starting time of the initial-driving of the spindle motor 58. Here, if the amount of the rotation load of the spindle motor 14 is calculated or detected, a predictive speed of the spindle motor 58 can be obtained, and the unit driving time period can be determined to perform the initial driving of the spindle motor 14 with a maximized driving efficiency according to the mount of the predictive rotation load and/or the predictive speed of the spindle motor 58.

The driving pulses are generated within the unit driving time period. It is possible that the intervals (widths) of the driving pulses can be determined according to a length of the unit driving time period.

It is also possible that a unit interval of each driving pulse can be determined from each variation of the predictive speed of the spindle motor 58 with respective to the reference or detected speed. Once the intervals of the respective driving pulses are determined, the unit driving time period can be determined to perform the open loop method until the closed loop method is performed. The interval (width) of the driving pulses corresponds to a length of a unit driving time during which a power or current is supplied to the spindle motor 58.

When a length of the unit driving time is extended, a large torque can be obtained from the spindle motor, but the driving speed becomes lowered. In contrast, the unit driving time is shortened, the driving speed is increased, and the large torque can not be obtained from the spindle motor.

When the unit driving time is determined to be proportional to the amount of the rotation load of the spindle motor 14 during the spindle motor initial-driving, the driving efficiency of the spindle motor 14 can be increased.

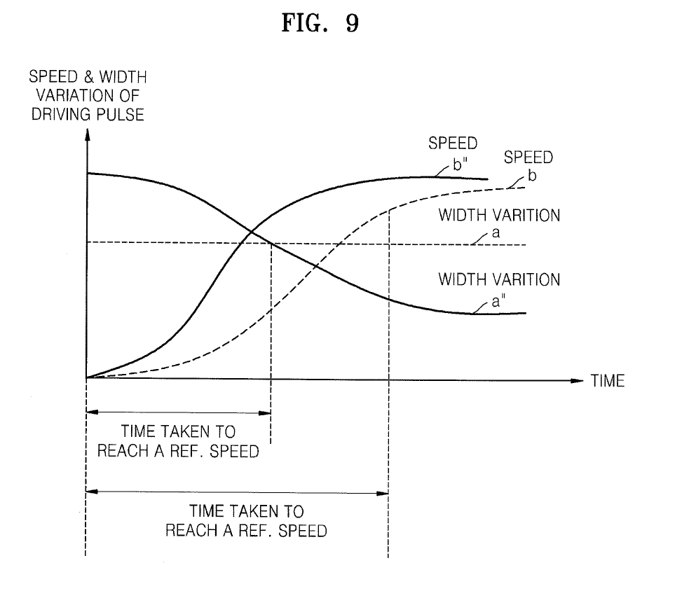

As described above, when a desirable or optimized length of the unit driving time can be obtained to correspond to a predictive speed b of FIG. 7, a graph a′ corresponding to a trajectory of the length of the driving time (interval or width) of the driving pulses can be obtained with respect to the lapse of time or the time taken from the initial-driving time as illustrated in FIG. 8.

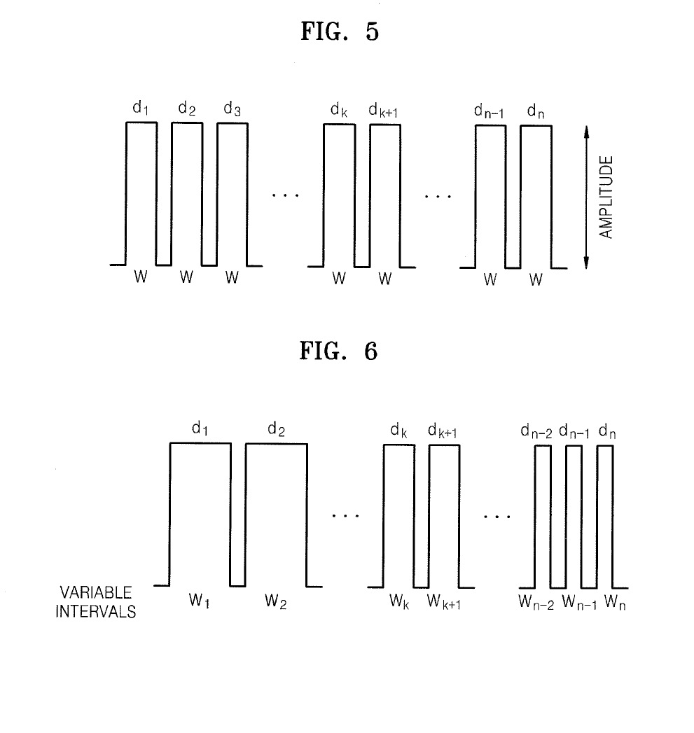

As illustrated in FIG. 6, driving pulses d₁, d₂, d₃, . . . dₖ, dₖ₊₁, dₙ₋₁, and dₙ corresponding to the trajectory a′ representing the length of the driving time are determined to perform the open loop method. That is, the driving pulses have widths w₁, w₂, w₃, . . . wₖ, wₖ₊₁, wₙ₋₁, and wₙ. The widths w₁, w₂, w₃, . . . wₖ, wₖ₊₁, wₙ₋₁, and wₙ may be different from each other. It is possible that the driving pulses d₁, d₂, d₃, . . . dₖ, dₖ₊₁, dₙ₋₁, and dₙ may be a plurality of groups of driving pulses, the driving pulses of each group having a same width.

As described above, the spindle motor 58 is driven using the driving pulses according to the graph a′ of FIG. 8 as illustrated in FIG. 6. The predictive speed b′ of the spindle motor 14 is obtained with respect to the time axis or the lapse of the time taken from the initial driving of the spindle motor 58 as illustrated in FIG. 8. The length of the unit driving time is obtained with respect to the time taken for the initial driving time. A final trajectory of a predictive speed of the spindle motor 58 can be obtained by repeating the above process. As illustrated in FIG. 8, the intervals (widths) of the respective driving pulses decrease along the time axis, and the predictive speed b of the spindle motor 58 increase along the time axis.

Therefore, a trajectory corresponding to the unit driving time can be obtained using the final trajectory of the predictive speed of the spindle motor 58. As described above, information on the length of the unit driving time with respect to the lapse of time or the time taken from the initial driving of the spindle motor 58 is obtained in the designing or manufacturing process of the spindle motor 58 of the disk drive apparatus and can be stored as the look-up table in the ROM 50.

By using the look-up table, the unit driving time corresponding to the interval (width) of the driving pulses can be determined with respect to the taken driving time, for example, the time axis, according to the predictive speed of the spindle motor 58. The above-generated driving pulses are applied to the spindle motor 58.

According to the present embodiment, the look-up table is used to determine the unit driving time. However, the present general inventive concept is not limited thereto. When a function of a length of a unit driving time having a time of the trajectory of the length of the unit driving time according to the final trajectory of the predictive speed of the spindle motor, as a variable, is determined, the unit driving time can be determined according to the lapse of the driving time through the computation of the function.

The driving pulses having variable intervals (widths) to correspond to the respective unit driving times and/or a unit driving period are determined in operation S403, and the determined driving pulses are generated in operation S404.

The driving pulses generated in operation S403 are applied to the spindle motor 14 in operation S405.

When the spindle motor 14 is driven using the driving pulses, a rotation position of the rotor 132 of the spindle motor 14 is detected in operation S406. A conventional method of detecting the rotation position of the rotor 132 can be uses to detect the rotation position of operation S406.

When the rotation position of the rotor is sensed in operation S406, it is determined whether a condition to perform the closed loop driving mode is satisfied in operation S407. The condition of the closed loop driving mode can be set as a condition where an amplitude (or amount) of the back electromotive force is greater than a minimum value required to control the speed of the spindle motor.

When the condition of the closed loop driving mode is satisfied, a condition to repeat a particular number of operations of sensing the rotation position of the rotor and driving the spindle motor according to a unit driving pulse (unit driving pulses). It is possible to set the condition of the closed loop driving mode as a condition where the amount of the back electromotive force is greater than an initial predetermined reference (critical) value.

When the condition of the closed loop driving mode is not satisfied in operation S407, operation S403 is preformed to determine a width of a next driving pulse (next driving pulses) of the open loop driving mode (period).

When the condition of the closed loop driving mode is satisfied in operation S407, the open loop driving mode is terminated, and the closed loop driving mode is performed to drive the spindle motor in operation S408. In the closed loop driving mode, a phase signal is generated according to the back electromotive force detected from the spindle motor 58, and acceleration driving control of the spindle motor is performed such that the speed of the spindle motor reaches a desirable speed using the rotation position of the rotor and the speed of the spindle motor generated from the generated phase signal.

As described above, the length of the unit driving time (interval) varies according to the predictive speed of the spindle motor in the open loop driving mode of the spindle motor, so that a driving efficiency of the open loop driving mode can be increased.

As illustrated in FIG. 9, when a graph a′ representing a variation of the interval of the driving pulses determined according to the predictive speed of the spindle motor is used to drive the spindle motor, a time taken to reach the speed of the spindle motor to a predetermined speed is shortened, compared to a convention spindle motor control apparatus controlling the speed of the spindle motor using driving pulses having a constant width. Accordingly, the acceleration efficiency of the spindle motor according to the present embodiment is increased, compared to a conventional spindle motor driving apparatus.

The present embodiment can be realized or performed as a method, an apparatus, or a system. When the present general inventive concept is embodied using software, elements of the present general inventive concept may be code segments to perform the method. Programs or code segments can be stored in a medium to be readable by a processor (computer), and/or can be transmitted by a computer data signal combined with a carrier in a communication network. The processor-readable medium may include any medium to store or transmit information data corresponding to the code segments. An example of the processor-readable medium is an electronic circuit, a semiconductor memory device, a ROM, a flash memory, an erasable ROM (EROM), a floppy disk, an optical disk, a hard disk, an optical fiber medium, a radio frequency (RF) network, etc. The computer data signal may be a signal transmittable through a transmission medium, such as an electronic network channel, an optical fiber, air, an electromagnetic field, an RF network, etc. The present embodiment illustrated in the drawings and descriptions is an example of the present general inventive concept. The present general inventive concept is not limited thereto. Since other changes can be made in the present general inventive concept, the present general inventive concept is not limited to structure or arrangement of the particular elements of the present general inventive concept. The present general inventive concept may be embodied as a hard disk drive apparatus and a data storage apparatus.

As described above, according to the embodiment of the present general inventive concept, the length of the unit driving time is variable according to a predictive speed of the spindle motor in the open loop driving condition when the spindle motor is initially driven, the initial driving efficiency of the spindle motor is improved and increased. The period time to reach a target speed of the spindle motor can be shortened in a critical condition.

As described above, when the reference driving pulses are applied to the spindle motor of the disk drive apparatus, the detected speed of the spindle motor may vary according to an environment of a location, area, place, or country where a user uses the disk drive apparatus and which can affect the performance of the spindle motor of the disk drive apparatus. The environment factor may be a temperature, a humidity, etc. It is possible that the reference driving pulses can be formed according to the environmental factor, that the detected speed of the spindle motor can be changed according to a change of the environmental factor, and that the environmental factor can be considered to calculate the predictive speed to be stored in the look-up table. Since the predictive speed variation with respect to a time axis can be determined according to the detected speed of the spindle motor to correspond to the environmental factor, the open loop mode of the disk drive apparatus can be shortened and the operation of the open loop mode can be performed to compensate for the environmental factor.

It is also possible that the predictive speed variation of the spindle motor with respect to a time axis may include a plurality of predictive speed variations to correspond to a plurality of environmental factors. The plurality of predictive speed variations each may have corresponding driving pulses having corresponding variable widths. One of the predictive speed variations can be selected to generate the corresponding driving pulses to be applied to the spindle motor.

According to the present general inventive concept, it is possible to extend a lifespan of a head in a disk drive apparatus since the above-described effective spindle driving reduces the contact time between the head and a disk.

Although a few embodiments of the present general inventive concept have been shown and described, it will be appreciated by those skilled in the art that changes may be made in these embodiments without departing from the principles and sprit of the general inventive concept, the scope of which is defined in the appended claims and their equivalents.

What is claimed is:

1. A method of a disk drive apparatus to drive a motor in an open loop mode, the method comprising:
changing widths of one or more driving pulses to be applied to a motor according to a predictive speed variation of the motor, in an open-loop driving mode.

2. The method of claim 1, further comprising:
applying reference driving pulses having a constant width to the motor; and
detecting a speed of the motor according to the applied reference driving pulses; and
setting up the predictive speed according to the detected speed with respect to a time axis.

3. The method of claim 1, further comprising:
storing the predictive speed in a memory as a look-up table,
wherein the changing of the widths of the driving pulses comprises changing the widths of the driving pulses according to the look-up table.

4. The method of claim 2, wherein:
the detecting the speed of the motor comprises detecting a reference speed and a reference time taken to reach the reference speed; and
the changing of the widths of the driving pulses comprises generating the driving pulses having the changeable widths to be supplied to the motor such that a time taken to the reference speed of the motor according to the driving pulses are shorter than the reference time.

5. The method of claim 1, wherein the predictive speed comprises a driving time period during which the driving pulses are generated.

6. The method of claim 1, wherein the predictive speed comprises unit driving times to correspond to the variable widths of the driving pulses.

7. The method of claim 1, wherein the open-loop driving mode comprises a mode to control the motor from a stationary state to a rotation state.

8. The method of claim 1, wherein the widths of the driving pulses decrease with respect to a time axis.

9. The method of claim 1, further comprising:
detecting a characteristic of the motor; and
determining the open loop driving condition according to the detected characteristic of the motor.

10. The method of claim 11, wherein the characteristic of the motor comprises at least one of a load, a speed, a position of the motor.

11. The method of claim 1, wherein the predictive speed variation of the motor represent a variation of the predictive speed determined according to an environment factor of the motor.

12. The method of claim 11, further comprising:
determining whether the open loop driving mode of the motor is met,
wherein the changing of the widths of the driving pulses comprises changing the width according to the determination.

13. The method of claim 11, wherein:
the open-loop driving condition for the motor is met when a back electromotive force is detected from the motor; and
the detected back electromotive force is smaller than a predetermined reference critical value.

14. The method of claim 1, wherein the open-loop driving mode of the motor is changed to a closed-loop driving mode when a back electromotive force of the motor is greater than a predetermined reference critical value after repeating driving the motor by a driving pulse corresponding to a unit driving time period, and detecting a position of a rotor of the motor.

15. The method of claim 1, wherein the changing of the widths of the driving pulses comprises changing the widths of the driving pulses in reverses proportional to a speed of the motor predicted according to a period of time taken to initial-drive the motor.

16. The method of claim 1, wherein the changing of the widths of the driving pulses comprises changing the widths of the driving pulses in proportional to a rotation load of the spindle motor predicted according to a period of time taken to initial-drive the spindle motor.

17. The method of claim 1, wherein the changing of the widths of the driving pulses comprises changing the widths of the driving pulses according to information set in a look-up table on a unit driving time period optimized by to a rotation load of the spindle motor with respect to a period of time taken to drive the spindle motor.

18. The method of claim 17, wherein the widths of the driving pulses are determined according to the unit driving time period, and the unit driving time period is determined in proportional to the rotation load of the spindle motor.

19. The method of claim 1, wherein the widths of the driving pulses are determined according to a function representing a trajectory of an optimized unit driving time period calculated based on a predictive speed trajectory of the motor.

20. The method of claim 1, wherein the open-loop driving mode comprises repeating a driving mode to drive the motor according to the driving pulses and a sensing mode to sense a rotation position of a rotor of the motor.

21. A disk drive apparatus comprising:
a disk;
a motor to rotate the disk; and
a controller to change widths of one or more driving pulses to be applied to the motor according to a predictive speed variation of the motor, in an open-loop driving mode.

22. The apparatus of clam 21, further comprising:
a memory to store a look-up table including the predictive speed variation of the motor,
wherein the predictive speed variation represents a variation of the widths of the pulses along a time axis.

23. The apparatus of clam 21, wherein the predictive speed variation represents a unit driving time period in which the controller generates the driving pulses.

24. The apparatus of claim 21, wherein the predictive speed variation represents a time taken to reach a reference speed of the motor according to the driving pulse, and the time is shorter than a time taken to reach the reference speed of the motor according to reference driving pulses having a constant width.

25. The apparatus of claim 21, wherein the widths of the driving pulses decrease with respect to a time axis.

26. The apparatus of claim 21, wherein the predictive speed variation of the motor represent a variation of the predictive speed determined according to an environment factor of the motor.

27. The apparatus of claim 21, wherein the controller determines whether the open loop driving mode of the motor is met, and changes the width according to the determination.

28. The apparatus of claim 27, wherein:
the controller determines the open-loop driving mode when a back electromotive force is detected from the motor; and
the detected back electromotive force is smaller than a predetermined reference critical value.

29. The apparatus of claim 21, wherein the open-loop driving mode of the motor is changed to a closed-loop driving mode when a back electromotive force of the motor is greater than a predetermined reference critical value after repeating driving the motor by a driving pulse corresponding to a unit driving time period, and detecting a position of a rotor of the motor.

30. The apparatus of claim 21, wherein the controller changes the widths of the driving pulses in reverses proportional to a speed of the motor predicted according to a period of time taken to initial-drive the motor.

31. The apparatus of claim 21, wherein the controller changes the widths of the driving pulses in proportional to a rotation load of the spindle motor predicted according to a period of time taken to initial-drive the spindle motor.

32. The apparatus of claim 21, wherein the controller changes the widths of the driving pulses according to information set in a look-up table on a unit driving time period optimized by to a rotation load of the spindle motor with respect to a period of time taken to drive the spindle motor.

33. The apparatus of claim 32, wherein the widths of the driving pulses are determined according to the unit driving time period, and the unit driving time period is determined in proportional to the rotation load of the spindle motor.

34. The apparatus of claim 21, wherein the widths of the driving pulses are determined according to a function representing a trajectory of an optimized unit driving time period calculated based on a predictive speed trajectory of the motor.

35. The apparatus of claim 21, wherein the open-loop driving mode comprises repeating a driving mode to drive the motor according to the driving pulses and a sensing mode to sense a rotation position of a rotor of the motor.

36. The apparatus of claim 21, wherein:
the controller generates a driving control signal having a unit driving time period variable according to an initial driving time period of the motor when a condition for the open loop driving mode is met; and
the driving pulses are generated according to the driving control signal, and are supplied to the motor.

37. The apparatus of claim 21, wherein the controller performs the open-loop driving when a back electromotive force is detected from the spindle motor, and the detected back electromotive force is smaller than a predetermined reference critical value.

38. The apparatus of claim 21, wherein the controller changes the open-loop driving to a closed-loop driving condition when the detected back electromotive force is greater than a predetermined reference critical value after repeating driving the motor by a driving pulse corresponding to a unit driving time period and detecting a position of a rotor of the motor.

39. The apparatus of claim 21, wherein the controller generates the driving control signal having the unit driving time period variable in reverses proportional to a speed of the motor predicted according to a period of time taken to initial-drive the motor.

40. The apparatus of claim 21, wherein the controller generates the driving control signal having the unit driving time period variable in proportional to a rotation load of the spindle motor predicted according to a period of time taken to initial-drive the motor.

41. The apparatus of claim 21, wherein the controller generates the driving control signal according to information set in a look-up table on the unit driving time period optimized by to a rotation load of the spindle motor with respect to a period of time taken to drive the motor.

42. The apparatus of claim 21, wherein the width of the driving pulse is determined according to the unit driving time period, and the unit driving time period is determined in proportional to the rotation load of the motor.

43. The apparatus of claim 42, wherein the controller changes the unit driving time period of the spindle motor according to a time taken to drive the motor using a function representing a trajectory of an optimized unit driving time period calculated based on a predictive speed trajectory of the motor.

44. The apparatus of claim 43, wherein the controller repeats a driving mode to drive the motor according to the driving pulse and a sensing mode to sense a rotation position of a rotor of the spindle motor, in the open-loop driving conditions for the motor.

45. A computer-readable medium to contain computer-readable codes as a program to perform a method of driving a motor in an open loop mode of a disk drive apparatus, the method comprising:
changing widths of one or more driving pulses to be applied to a motor according to a predictive speed variation of the motor, in an open-loop driving mode.
